(19) United States
(12) Patent Application Publication
(10) Pub. No.: US 2002/0174066 A1
(43) Pub. Date: Nov. 21, 2002

(54) Method and apparatus for automating the process of settling financial transactions

(76) Inventors: James E. Kleckner, Palo Alto, CA (US); Renee D. Benton, Union City, CA (US); Minh T. Tran, San Francisco, CA (US)

Correspondence Address: A. Richard Park, Park & Vaughan LLP, Suite 201, 508 Second Street, Davis, CA, 95616, US

(21) Appl. No.: 10/105,517

(22) Filed: Mar. 25, 2002

Related U.S. Application Data
(60) Provisional application No. 60/291,199, filed on May 15, 2001.

(51) Int. Cl. G06F 17/60

(52) U.S. Cl. 705/39

(57) ABSTRACT

One embodiment of the present invention provides a system for automatically settling a financial transaction. This system operates by receiving a trade record specifying previously-agreed-to details of the financial transaction between a first party and a second party. This trade record includes settlement instructions specifying a transfer of a first financial instrument belonging to the first party into a second party destination account belonging to the second party. It also includes a second digital signature created by digitally signing at least a portion of the trade record, including the settlement instructions, with a second private key belonging to the second party. Upon receiving this trade record, the system attempts to ensure that funds are available to complete the financial transaction. If funds can be ensured, the system causes the first financial instrument to be transferred into the second party destination account on condition that the second digital signature can be verified using a corresponding second public key.

### RELATED APPLICATION

This application hereby claims priority under 35 U.S.C. §119 to U.S. Provisional Patent Application No. 60/291,199 filed May 15, 2001.

### BACKGROUND

1. Field of the Invention

The present invention relates to computer-based systems for trading financial instruments. More specifically, the present invention relates to a method and an apparatus that uses digital signatures to automate the process of settling financial transactions, such as foreign exchange transactions.

2. Related Art

The foreign exchange market is the largest and most liquid market in the world. In 1998, the Federal Reserve Bank of New York estimated, that daily turnover was approximately $1.5 trillion.

Unlike stocks, which are market-traded, foreign exchange is primarily an over-the-counter market. There is no such thing as a “price” for a particular transaction. Rather, each dealer, bank, broker, or other trading source, provides their own rate for each transaction.

The trading and settlement processes for a typical foreign exchange transaction are illustrated in FIG. 1. A trader 102, working on behalf of a corporation or other entity, makes a quote request 106 to a trader 104, working on behalf of a bank. In response to this quote request, trader 104 makes a quote 108 proposing a rate for the transaction.

Trader 102 accepts the quote by sending an acceptance message to trader 104, in which case trader 104 typically sends an acknowledgement message 112 back to trader 102.

Note that the communication process outlined above typically takes place over the telephone or via facsimile.

After traders 102 and 104 agree to the terms of the transaction, trader 102 communicates trade information to settlement clerk 118, who works on behalf of the same organization as trader 102. Similarly, trader 104 communicates trade information 116 to settlement clerk 120, who works on behalf of the same organization as trader 104.

Settlement clerks 118 and 120 are responsible for actually causing funds to be transferred between accounts of the two organizations involved in the trade. Before doing so, settlement clerks 118 and 120 communicate and confirm settlement information 122 with each other. This settlement information 122 confirms the terms of the trade, and additionally specifies the accounts between which funds are to be transferred.

Note that settlement clerks 118 and 120 typically communicate settlement information 122 via telephone or facsimile. In some cases, this settlement information is communicated through a third party payment matching system 128.

After the settlement information is communicated, and if the terms of the deal are in agreement, settlement clerk 118 communicates with funds transfer agent 126, who actually transfers the funds. Similarly, settlement clerk 120 communicates with funds transfer agent 124 to transfer funds in the reverse direction.

Note that the separation of roles between trading and settlement provides a measure of protection against fraud because collusion between a trader and a settlement clerk is required to perpetrate most types of fraud. However, this protection has a price, because the many manual communications, validations, and confirmations involved in the role-based trading and settlement processes are time-consuming and expensive.

Also note that the trade terms and settlement instructions are typically entered manually on both sides of the transaction. Consequently, the trade terms and settlement instructions are often not entered in the same way, and may not match. Even if the trade terms and settlement instructions are entered properly, netting and aggregation can cause trades not to match. If trades do not match, a great amount of additional work is required to sort out inconsistencies.

What is needed is a method and an apparatus for facilitating trading and settlement of financial instruments, such as currencies, without the time-consuming manual processes involved in existing trading, settlement, and confirmation processes.

Note that a certain amount of risk is inherent in the settlement process. During a foreign exchange transaction, funds are typically transferred from a first party to a second party in exchange for funds being transferred from the second party to the first party. If the transfer to the second party fails because the first party lacks sufficient funds, it is possible for second party to transfer funds to the first party without receiving funds in return.

Since these transfers can be very large (possibly hundreds of millions or billions of dollars), the failed transfer may cause the second party to lack funds to honor other transactions. This problem can rapidly spread to other parties until the trading system grinds to a halt.

Hence, what is needed is a method and an apparatus for reducing settlement risk during the process of settling financial transactions.

### SUMMARY

One embodiment of the present invention provides a system for automatically settling a financial transaction. This system operates by receiving a trade record specifying previously-agreed-to details of the financial transaction between a first party and a second party. This trade record includes settlement instructions specifying a transfer of a first financial instrument belonging to the first party into a second party destination account belonging to the second party. It also includes a second digital signature created by digitally signing at least a portion of the trade record, including the settlement instructions, with a second private key belonging to the second party. Upon receiving this trade record, the system attempts to ensure that funds are available to complete the financial transaction. If funds can be ensured, the system causes the first financial instrument to be transferred into the second party destination account on condition that the second digital signature can be verified using a corresponding second public key.

In one embodiment of the present invention, the settlement instructions additionally specify a first party source account from which the first financial instrument is to be transferred. In this embodiment, the trade record additionally includes a first digital signature created by digitally signing at least a portion of the trade record including the settlement instructions with a first private key belonging to the first party.

In a variation on this embodiment, ensuring that funds are available to complete the financial transaction involves causing a hold to be placed on the first financial instrument within the first party source account, so that the first financial instrument is ensured to be available to be transferred into the second party destination account.

In one embodiment of the present invention, causing the first transfer involves communicating at least a portion of the trade record, including the settlement instructions and the second digital signature, to a first clearing agent so that the first clearing agent can use the corresponding second public key to verify that the second digital signature was created using the second private key prior to transferring the first financial instrument into the second party destination account.

In one embodiment of the present invention, the settlement instructions additionally specify a transfer of a second financial instrument to a first party destination account. In this embodiment, the trade record includes a first digital signature created by digitally signing at least a portion of the trade record including the settlement instructions using a first private key belonging to the first party.

In a variation in this embodiment, causing the transfer of the second financial instrument into the first party destination account involves communicating at least a portion of the trade record, including the settlement instructions and the first digital signature, to a second clearing agent, so that the second clearing agent can use a first public key to verify that the first digital signature was created using the first private key prior to transferring the second financial instrument into the first party destination account.

In one embodiment of the present invention, ensuring that funds are available to complete the financial transaction involves causing the transfer of the first financial instrument from the first party into a first escrow account, so that the first financial instrument is available to be transferred into the second party destination account.

In one embodiment of the present invention, ensuring that funds are available to complete the financial transaction involves verifying a payment guarantee contained within the trade record, the payment guarantee having been previously provided by the first party. This payment guarantee ensures that the first financial instrument is available to be transferred to the second party destination account. In a variation on this embodiment, the payment guarantee includes a record that a hold has been placed on the first financial instrument within a first source account. In another variation on this embodiment, the payment guarantee includes the first financial instrument in digital form.

In a variation on this embodiment, the system additionally records the settlement operation in a database.

In a variation on this embodiment, the system additionally validates an identity of the first party by using a public key of a certification authority to verify that a certificate containing the public key of the first party was signed by a corresponding private key belonging to the certification authority. This signing by the certification authority indicates that the certification authority has verified the identity of the first party.

In a variation on this embodiment, the financial transaction involves foreign exchange, and the trade record includes: a trade identifier; a trade date; an identifier for a first currency; a first currency amount; an identifier for a first organization providing the first currency; an identifier for a second currency; a second currency amount; and an identifier for a second organization providing the second currency.

### BRIEF DESCRIPTION OF THE FIGURES

FIG. 1 illustrates typical trading and settlement processes.

FIG. 2 illustrates an exchange that facilitates automated trading and settlement in accordance with an embodiment of the present invention.

FIG. 3 illustrates how credentials and permissions are granted in accordance with an embodiment of the present invention.

FIG. 4 is a flow chart illustrating the process of obtaining a credential from a certification authority in accordance with an embodiment of the present invention.

FIG. 5A is a flow chart illustrating how an exchange security officer is authorized in accordance with an embodiment of the present invention.

FIG. 5B is a flow chart illustrating how a security officer obtains authority to grant permissions in accordance with an embodiment of the present invention.

FIG. 6 is a flow chart illustrating the process of obtaining a permission from a security officer in accordance with an embodiment of the present invention.

FIG. 7 is a flow chart illustrating the process of facilitating a trade in accordance with an embodiment of the present invention.

FIG. 8 is a flow chart illustrating the process of settling a trade in accordance with an embodiment of the present invention.

FIG. 9 illustrates the structure of a trade record in accordance with an embodiment of the present invention.

FIG. 10 is a flow chart illustrating the process of establishing a policy for a trade and/or amendment approvals in accordance with an embodiment of the present invention.

FIG. 11 illustrates entities involved in the settlement process in accordance with an embodiment of the present invention.

FIG. 12 is a flow chart illustrating the settlement process in accordance with an embodiment of the present invention.

FIG. 13 is a flow chart illustrating the settlement process in accordance with another embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Exchange System

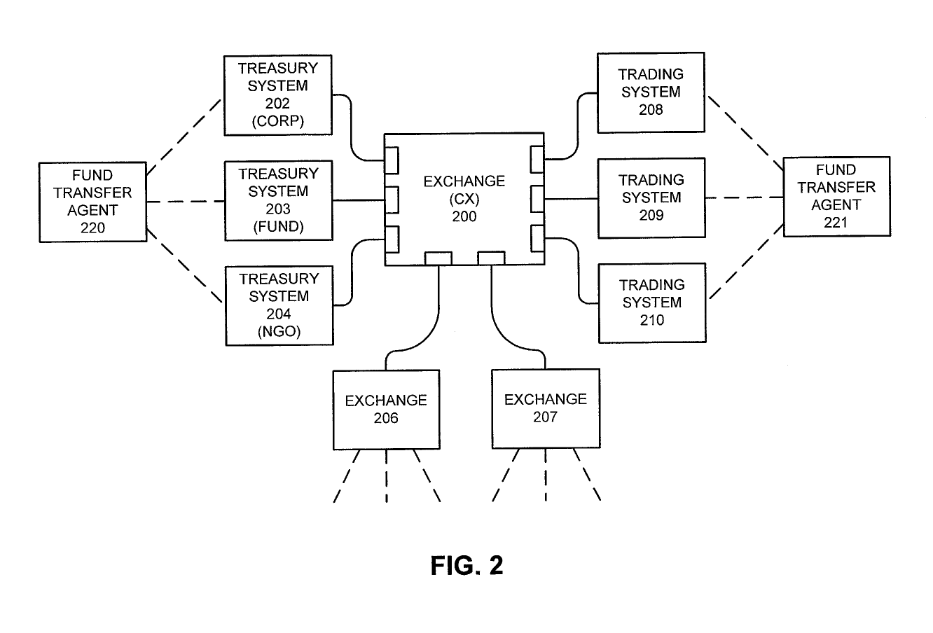

FIG. 2 illustrates an exchange 200 that facilitates automated trading and settlement in accordance with an embodiment of the present invention. Exchange 200 facilitates trades between treasury systems 202-204 and trading systems 208-210. Exchange 200 can additionally be coupled to a number of other exchanges 206-207. Note that exchange 200, treasury systems 202-204 and trading systems 208-210 run on computer systems. These computer systems can generally include any type of computer system, including, but not limited to, a computer system based on a microprocessor, a mainframe computer, a digital signal processor, a portable computing device, a personal organizer, a device controller, and a computational engine within an appliance.

Also note that linkages show in FIG. 2 pass across one or more computer networks (not shown). These networks generally include any type of wire or wireless communication channel capable of coupling together computing nodes. This includes, but is not limited to, a local area network, a wide area network, or a combination of networks. In one embodiment of the present invention, the network includes the Internet.

Treasury systems 202-204 generally belong to organizations requiring foreign exchange services, such as corporations, funds or non-governmental organizations (NGOs) but could also include banks requesting trades. Hence, treasury systems 202-204 generally request quotes for from trading systems 208-210, and accept quotes from trading systems 208-210.

Trading systems 208-210 generally belong to banks providing foreign exchange services but could include other organizations that choose to act as quote makers. Hence, trading systems 208-210 generally receive quote requests from treasury systems 202-204, and make quotes to be accepted by treasury systems 202-204.

Treasury systems 202-204 are coupled to one or more funds transfer agents, such as funds transfer agent 220, which carry out instructions to actually transfer funds between accounts. Similarly, trading systems 208-210 are coupled to one or more funds transfer agents, such as funds transfer agent 221. Note that funds transfer agents 220 and 221 may be the same funds transfer agent.

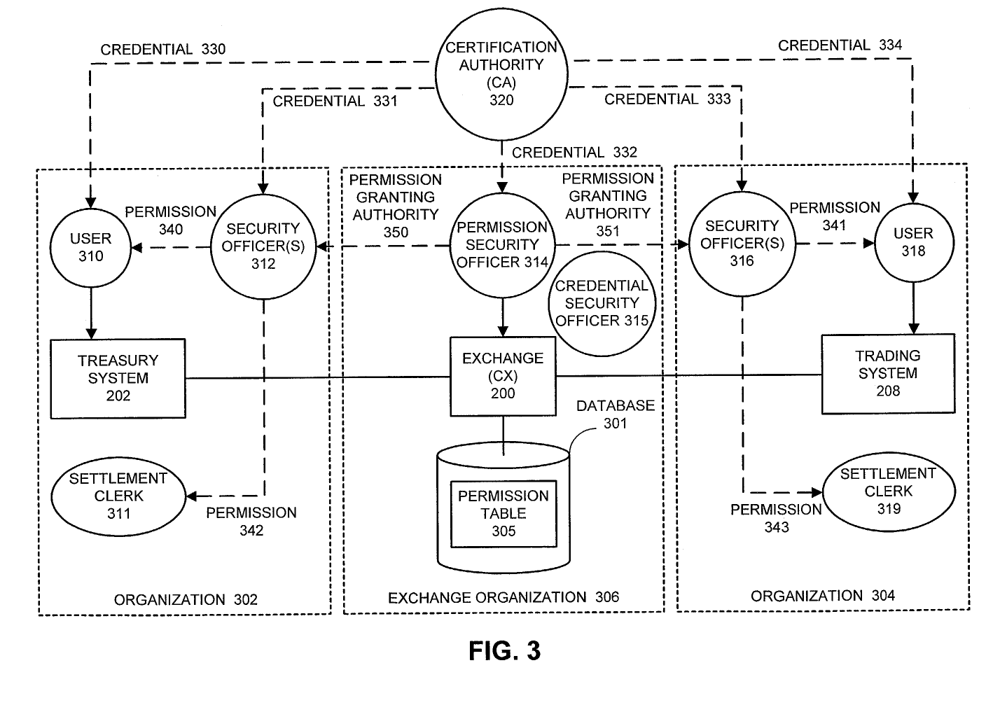

Exchange 200 communicates secure, authenticated quote requests, quotes and quote acceptances between treasury systems 202-204 and trading systems 208-210. Exchange 200 also facilitates communication of settlement instructions between treasury systems 202-204 and trading systems 208-210. These functions are described in more detail with reference to FIGS. 3-9 below.

Note that exchange 200 can additionally be coupled to exchanges 206-207 to facilitate cross-exchange transactions.

Relationships Between Actors and Organizations

FIG. 3 illustrates the relationships and interactions of the involved actors and organizations in accordance with an embodiment of the present invention. In FIG. 3, organization 302 trades with organization 304 through exchange 200. Certification authority 320 often includes an independent entity, such as an accounting firm or an independent certification authority, that verifies the identity of users and grants credentials for use by various actors belonging to organizations 302-304 and to exchange organization 306.

More specifically, organization 302 includes treasury system 202, which communicates with exchange 200. Treasury system 202 operates under control of user 310, such as a front office trader, who receives permissions from a local security officer 312, who also is associated with organization 302. Organization 302 also includes a settlement clerk 311, who is responsible for settling trades made by user 310.

Similarly, organization 304 includes trading system 208, which communicates with exchange 200. Trading system 208 operates under control of user 318, who receives permissions from a local security officer 316, who is also associated with organization 304. Organization 304 also includes a settlement clerk 319, who is responsible for settling trades made by user 318.

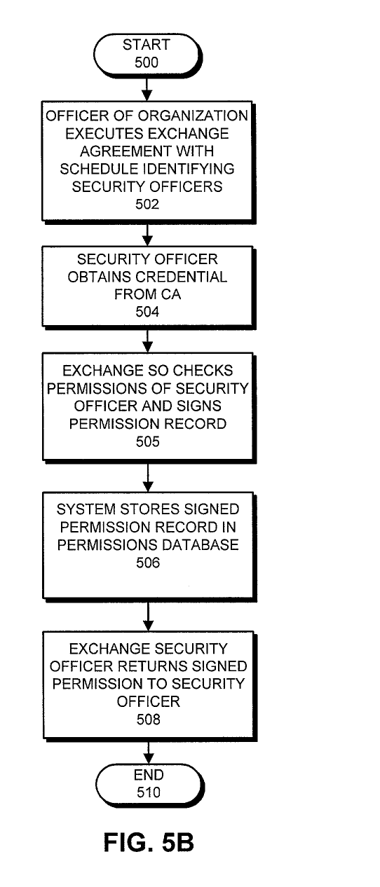

Exchange organization 306 includes exchange 200 as well as permission security officer 314, who confers permission granting authority to local security officers 312 and 316 in conjunction with CA 320 through the process outlined in FIG. 5 below. Note that exchange 200 is coupled to a database 301, which contains permission table 305. Permission table 305 contains permissions for users 310 and 318, security officers 312 and 316, and settlement clerks 311 and 319.

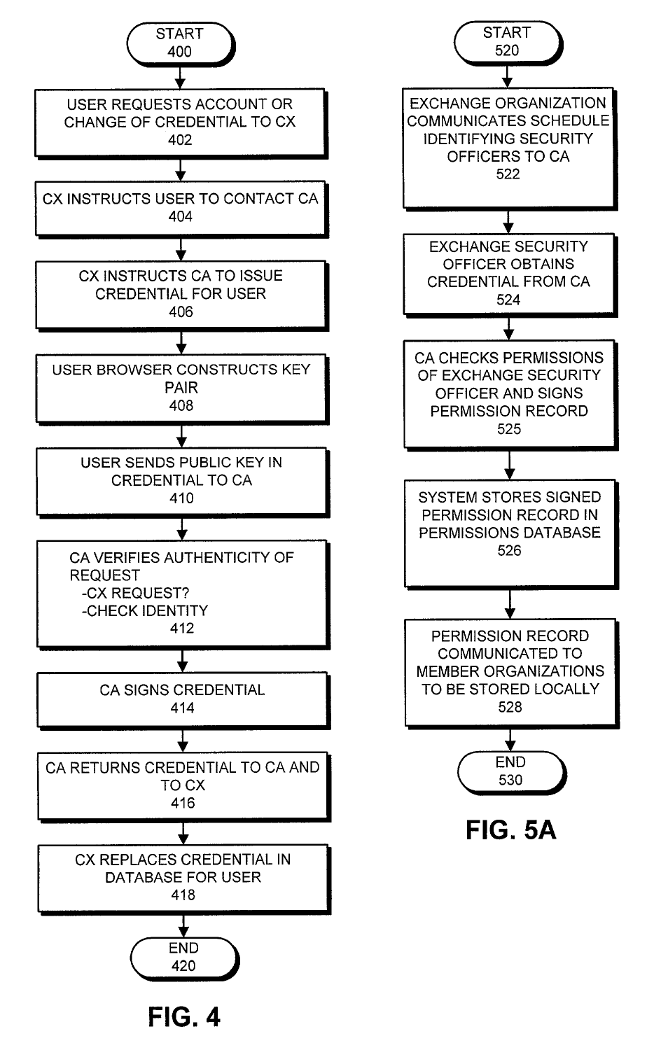

All of the above-described entities receive credentials from independent certification authority (CA) 320, which grants credentials to users 310 and 318, security officers 312, 314 and 316, and settlement clerks 311 and 319. This credential granting process is described below with reference to FIG. 4.

During operation of the system illustrated in FIG. 3, CA 320 generates credentials 330-334 that are used by actors, such users 310 and 318, security officers 312, 314 and 316 and settlement clerks 311 and 319 to validate identities.

In addition to validating identities, the system illustrated in FIG. 3 validates permissions to perform operations, such as trading and settling trades, and can embed information into the trading records so that these validations can be performed independently by organizations 302 and 304. Permission security officer 314, who belongs to exchange organization 306, confers permission granting authority on security officers 312 and 316 belonging to organizations 302 and 304, respectively. Security officers 312 and 316 in turn grant trading permissions 340 and 341 to users 310 and 318, respectively. Security officers 312 and 316 can also grant settlement permissions 342 and 343 to settlement clerks 311 and 319, respectively. Note that users 310 and 318 require both permissions and credentials in order to perform actions, such as trading and settling trades.

Note that in the present invention, permissions for various actors are stored within a central permission table 305, instead of being embedded within certificate chains in credentials of the actors. Table 305 correlates permission additions, subtractions and modifications to provide an up to date unified view of all user authorizations in the system. Table 305 stores the signed permission request records that can be used to determine the entity (security officer) that granted the particular permission to the individual. When a user's authorizations are queried, permission table 305 returns a signed response containing the collection of signed permission requests associated with the user along with a timestamp value to validate the user's permissions at the time of the query. Since permission queries can be performed concurrently with permission updates, the system defines a minimum quiescent period (typically <10 seconds) which delays the recognition of permission changes to allow queries to complete in a consistent state.

Also note that in one embodiment of the present invention, there exist multiple security officers for organization 302, organization 304 and exchange organization 306. In this embodiment, more than one security officer must agree in order to change the privileges of a security officer. This prevents a single security officer from unilaterally changing his or her own privileges. The organization 302 or 304 may also specify that more than one security officer is required to agree to authorize permissions of other users as well.

Process of Bootstrapping Exchange Security Officers

In order to bootstrap the system, exchange organization 306 must first initiate the creation of at least two exchange security officers: a Credential Security Officer (CSO) 315 and a Permission Security Officer (PSO) 314. These two security officers must be independent individuals in order to enforce a separation of duties. Exchange organization 306 communicates a schedule to CA 320 identifying these security officers within exchange organization 306. The two security officers CSO 315 and PSO 314 may then request and receive credentials 332 from CA 320 following the procedure outlined in FIG. 4.

Once the credentials are granted, exchange organization 306 must then initiate the creation of permissions for the two security officers. Note that it is desirable that “credential creation” and “permission creation” permissions be mutually exclusive to maintain separation of duties. Ideally, no single actor in the system should be granted both “credential creation” and “permission creation” permission as a safeguard for fraud. Exchange organization 306 communicates a schedule to CA 320 granting the following permissions to the respective security officers:

Credential Security Officer (CSO)

CSO credential creation permission

PSO credential creation permission

Permission Security Officer (PSO)

CSO permission creation permission

PSO permission creation permission

Once the two initial security officers are successfully bootstrapped with the appropriate credentials and permissions, additional exchange CSOs and PSOs can be added into the system. The original CSO 315 can first create and approve a new CSO. The original PSO 314 may then confer CSO permissions upon the new CSO. At that point, the newly created CSO is functionally identical to the bootstrapped CSO. Similarly an additional PSO may be created within the system. Exchange organization 305 may wish to establish more restrictive guidelines concerning the creation of CSOs and PSOs requiring the approval to multiple CSOs or PSOs respectively. In such instances, the bootstrap process must be augmented by the appropriate number of security officers to ensure the guidelines are met.

Process of Bootstrapping Member Organization Security Officers

Independent organizations that may wish to join the system can request the appropriate credentials and permissions for their own CSO and PSO representatives who then have the authorization to grant credentials and permissions for users within their own organization. Member organization 302 communicates a schedule to a CSO in exchange organization 306 identifying these designated security officers within member organization 302. Once these credentials are requested and received, the member organization can communicate a schedule of permissions for a PSO in exchange organization 306 granting the following permissions:

Credential Security Officer (CSO)

CSO credential creation permission

PSO credential creation permission

User credential creation permission

Permission Security Officer (PSO)

CSO permission creation permission

PSO permission creation permission

Trading permission creation permission

Settlement permission creation permission

Additional permissions may be defined as required. Certain permissions such as the trading permission and settlement permission should ideally be identified as mutually exclusive in order to eliminate the possibility of a single actor committing fraud within the system.

Once the two initial security officers are successfully bootstrapped with the appropriate credentials and permissions, additional organization CSOs and PSOs can be added into the system as well as organization users that will be conducting trades and settlements. This distributed mechanism allows the member organizations to independently manage their authentication and authorization functions according to their internal policies and procedures.

Process of Obtaining a Credential

FIG. 4 is a flow chart illustrating the process of obtaining a credential 330 for a user 310 in accordance with an embodiment of the present invention. Note that in one embodiment of the invention, this credential is implemented as a digital certificate. The process starts when user 310 requests a credential 330 from an organization CSO. In response to the request, CSO instructs user 310 to contact CA 320 (step 404). The organizational CSO additionally instructs CA 320 to issue a credential for user 310 (step 406).

Next, user 310 constructs a public key/private key pair (step 408) through their browser or a hardware cryptographic token, and then sends the newly created public key along with a request for a credential to CA 320 (step 410).

CA 320 then verifies the authenticity of the request (step 412). This process involves determining if a CSO has instructed CA 320 to issue the credential 330. It also involves performing some type of manual or automated identity check on user 310. For example, the check can involve a database lookup of information on user 310, an interview with user 310, a telephone call to user 310 or a facsimile communication with user 310. In one embodiment, a unique randomly generated personal identification number (PIN) is communicated by the CSO to both user 310 and CA 320 that identifies to CA 320 this request for a credential is valid. This PIN can only be used once to request signing of the credential by CA 320. The user's corresponding PSO will authenticate requests for permission by signing permissions in the permission table 305 (see below).

If the request is properly verified, CA 320 signs credential 330 with a private key belonging to CA 320 (step 414), and returns credential 330 to user 310 and to CX 200 (step 416). CX 200 then places the new credential 330 for user 310 in its database 301 (step 418). Note that credential 330 is signed by CA 320 and includes a public key for user 310.

Process of Validating a Credential

Throughout the trade creation, amendment and settlement process, the actors in the system including users 310 and 318, security officers 312, 314 and 316, and settlement clerks 311 and 319 may require validation of the credentials of fellow actors with whom they are interacting within the system. In one embodiment of the invention, the permission table 305 acts as the system of record for credential validity. The status of credentials 330-334 may be confirmed as valid by querying the permission table. If the credential presented for validation matches a credential stored in permission table 305, the system returns a signed response containing a timestamped credential record that confirms the validity of the credential. If the credential is not found in permission table 305, the system returns a signed, timestamped response that indicates that the queried credential was not valid. In one embodiment of the invention, actors may query the validity of a credential by checking if the digital certificate is listed with a revoked status in a Certificate Revocation List (CRL) published by certification authority 320. An alternate method would be to send an Online Certificate Status Protocol request (OCSP) to certification authority 320 to query the real-time status of the digital certificate.

If a credential does not successfully verify, ideally the actor should not be permitted to continue their participation within the system and their requested action should be blocked from further execution.

Process of Obtaining a Permission

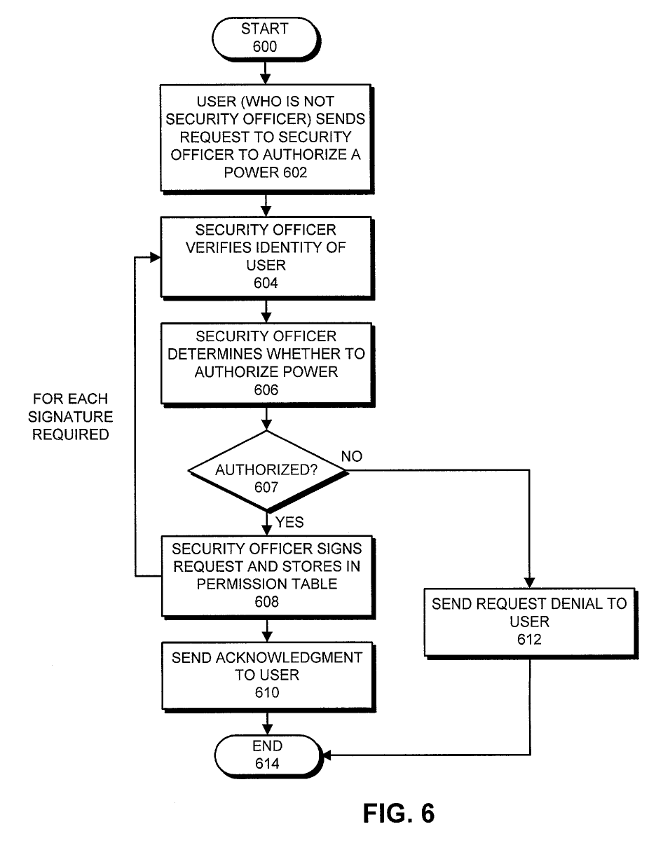

FIG. 6 is a flow chart illustrating the process of obtaining a permission 340 from a organization PSO for a user 310 in accordance with an embodiment of the present invention. User 310 first sends a request to a PSO to obtain a permission, such as the permission to trade (step 602). The request contains information including the user's credential and a unique string that identifies the permission that the user is requesting and is signed by the user's private key. The PSO then validates the identity of user 310 by retrieving the public key for user 310 from the permission table 305 and using the public key to validate the signature of the request. If the identity validates, the PSO determines whether to grant the permission based upon authorization rules and processes defined by organization 302 (step 606). If the permission is to be granted, the PSO signs the request with a private key belonging to the PSO. The system performs an internal query of permission table 305 to verify that the PSO has the appropriate permission to grant permissions to user 310 and if the query is successful, the request is stored within permission table 305 (step 608). Steps 604 through 608 are then repeated for each signature required by the authorization policy of the organization 302. Note that for some users, such as security officers, organizations may establish policies that may require signatures from multiple security officers in order to add/modify/remove their permission records. This prevents a single security officer from unilaterally authorizing powers for himself. Also note that requiring multiple signatures generally increases the security of the system because multiple actors are required to collude in order to improperly authorize additional powers for a user.

The PSO then sends an acknowledgement to user 310 to complete the process (step 610).

If the permission is not to be granted, the PSO sends a request denial to user 310 (step 612).

Note that permission table 305 contains an entry for each user. This entry contains a number of fields indicating various permissions. The entry also stores the signed timestamped permission requests associated with the permissions that have been granted for each user. For example, a given entry for user 310 may include a collection of unique string identifying the user's permissions as well as the signed permission requests associated with the user.

Process of Validating a Permission

Throughout the trade creation, amendment and settlement process, the actors in the system including users 310 and 318, security officers 312, 314 and 316, and settlement clerks 311 and 319 require validation of the permissions of fellow actors with whom they are interacting within the system. In the present invention, the actors can append their relevant permissions to a trade record to validate their authorization to perform trading functions. Actors can request a timestamped permission record to document this authorization from CX 200. The status of permissions 340, 341, 350 and 351 can also be confirmed through a query of permission table 305. A query of the permission table may consist of a credential 330-334 and a permission string. The response to a permission query includes the credential, all relevant signed permission requests and a timestamp signed by CX 200.

Process of Facilitating a Trade

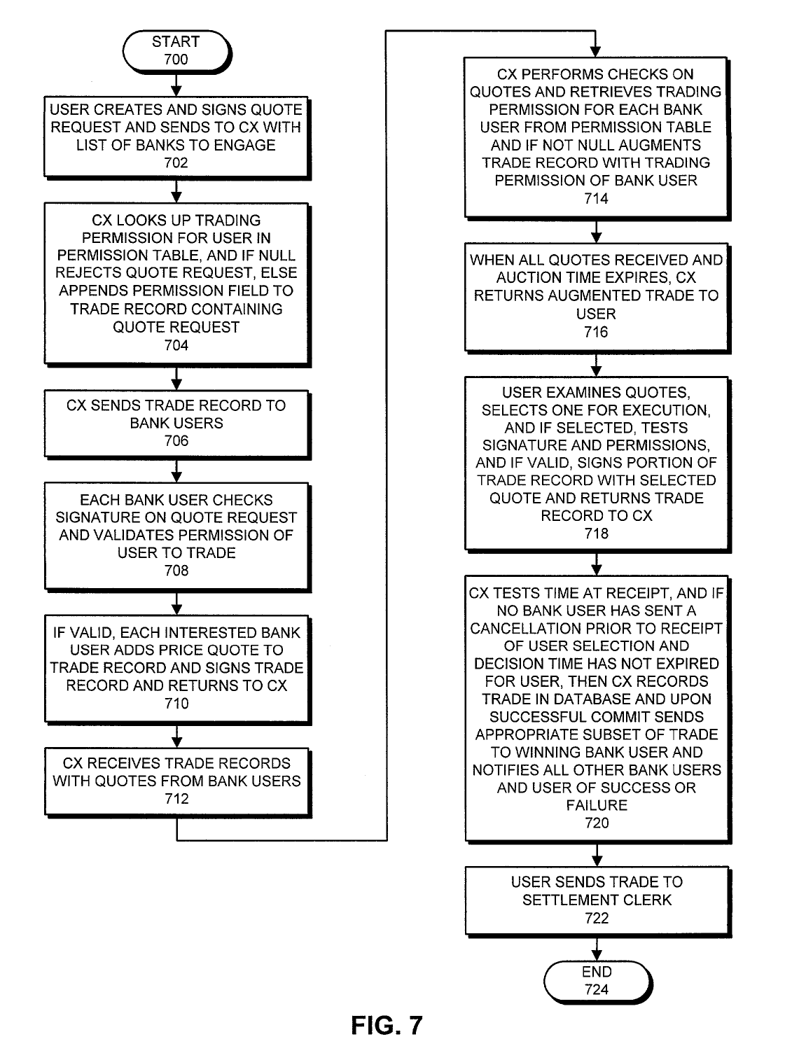

FIG. 7 is a flow chart illustrating the process of facilitating a trade in accordance with an embodiment of the present invention. This process starts when a user 310 creates and digitally signs a quote request, and sends the quote request to CX 200 (step 702). Note that this quote request can include a list of banks to engage.

Also note that the term “digitally signing” refers to the process of encrypting the computed hash value of a message with a private key belonging to a first entity to generate a “digital signature”. Other entities can then verify that the message was signed by the private key belonging to the first entity by decrypting the signature with the public key belonging to the first entity and comparing the result to the computed hash of the message that the signature was attached to.

Upon receiving the quote request, CX 200 looks up the trading permission for user 310 in permission table 305. If the entry in permission table 305 is null (empty), CX 200 rejects the quote request. Otherwise, CX 200 appends a timestamped signed trading permission for user 310 to a trade record containing the quote request (step 704). CX 200 then sends the trade record to the specified bank users (step 706).

Each bank user 318 who receives the trade record checks the signature on the quote request to validate the identity of user 310, and also checks permission information in the trade record to verify that user 310 has permission to perform the trade (step 708) and that the permission was granted by authorized exchange security officers.

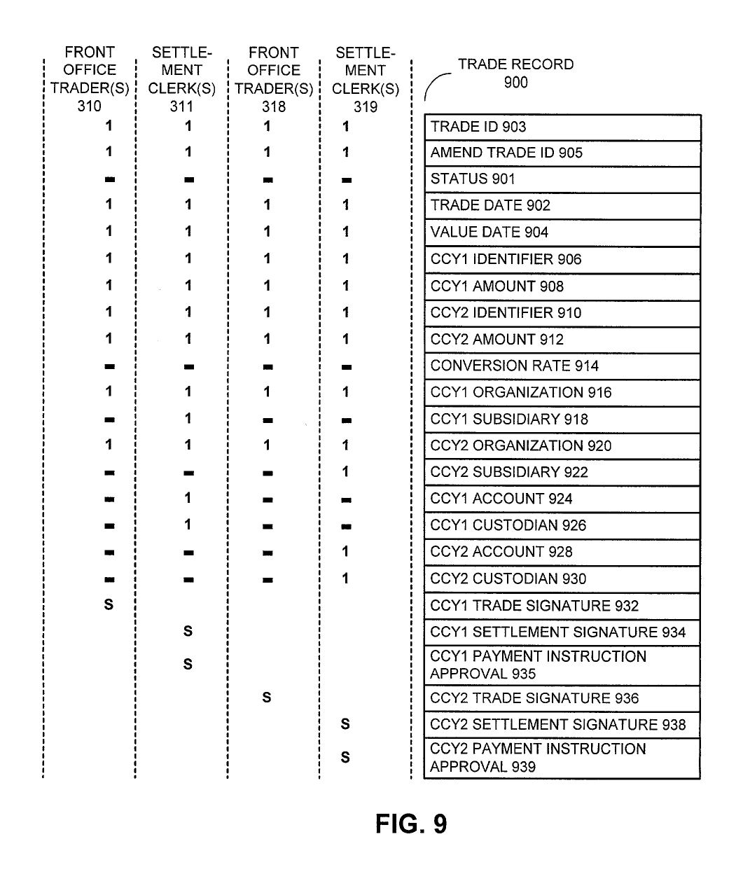

If the identity and permission are valid, each interested bank user 318 adds a price quote to the trade record, signs the appropriate fields (as described with reference to FIG. 9) of the trade record, appends the signature, and returns the trade record to CX 200 (step 710).

Next, CX 200 receives trade records with quotes from interested bank users (step 712). CX 200 then performs checks on the quotes and retrieves trading permissions for each interested bank user from permission table 305. If these trading permissions are not null, CX 200 appends the permissions to the trade record (step 714).

When all quotes have been received and the auction time expires, CX 200 returns a compiled quote record along with the augmented trade record to user 310 (step 716). Note that although the present example is presented in the context of a reverse auction, the present invention can generally be applied to trading and settling systems that use any type of pricing mechanism, and is not limited to reverse auctions.

Next, user 310 examines all of the quotes in the compiled quote record, and selects one for execution. If a quote is selected, user 310 tests the signature and permissions of the quote. If these are valid, user 310 signs the portion of the trade record with the selected quote, and returns the trade record to CX 200 (step 718).

Upon receiving the trade record, if no bank user has sent a cancellation prior to receipt of the user selection, and if the decision time has not expired for user 310, CX 200 records the trade in database 301. Upon successful commit, CX 200 sends the appropriate subset of the trade to the winning bank user, and informs all other bank users and user 310 of success or failure (step 720).

Next, bank user 310 sends the trade record to settlement clerk 311 within the same organization 302 to settle the trade (step 722).

Process of Settling a Trade

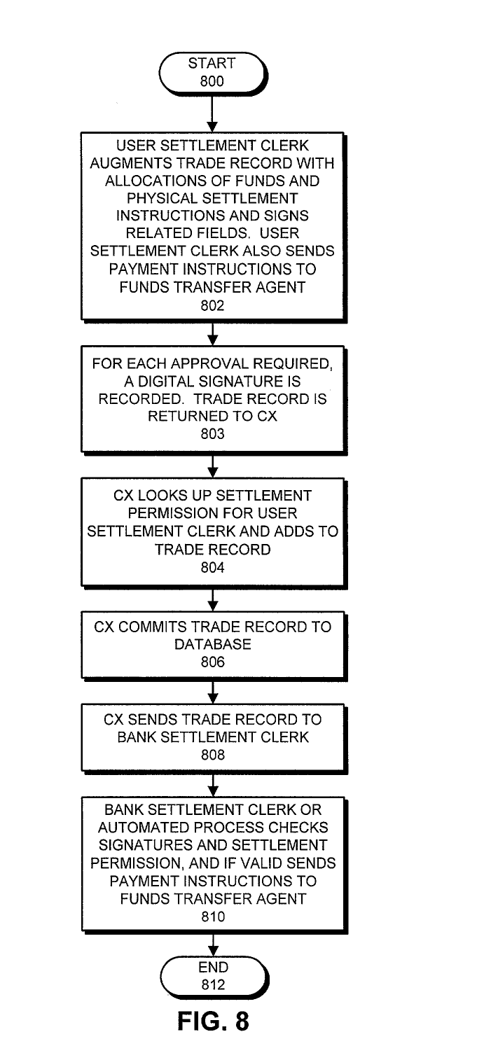

FIG. 8 is a flow chart illustrating the process of settling a trade in accordance with an embodiment of the present invention. The process starts when settlement clerk 311 augments the trade record with allocations of funds and physical settlement instructions. Settlement clerk 311 then signs the related fields of the trade record (step 802). Note that if the settlement instructions are default (standing) instructions, settlement clerk 311 may not have to append additional settlement instructions to the trade record. Settlement clerk 311 also sends payment instructions to funds transfer agent 220.

Next, for each additional approval required in the approval policy for organization 302 a digital signature is requested from the appropriate actors and recorded within the trade record, and the trade record is then returned to CX 200 (step 803).

Upon receiving the trade record, CX 200 looks up the settlement permission for settlement clerk 311. If this permission is not null, CX 200 adds a timestamped record of the permission to the trade record (step 804). CX 200 then commits the trade record to database 301 (step 806), and sends the trade record to bank settlement clerk 319 (step 808).

Upon receiving the trade record, bank settlement clerk 319 checks the signatures and settlement permissions of settlement clerk 311, and possibly checks other signatures and permissions in the trade record. If all are valid, settlement clerk 319 sends instructions to funds transfer agent 221 to complete the trade (step 810). Note in one embodiment of the present invention, bank settlement clerk 319 can determine if there are enough signatures by performing a query CX 200 to retrieve a signed policy record.

Trade Record Structure

FIG. 9 illustrates the structure portions of a trade record 900 in accordance with an embodiment of the present invention to trade Spot Foreign Currency Exchange (FX). Trade record 900 includes a number of fields, some of which are illustrated in FIG. 9.

These fields include trade ID 903 and amend trade ID 905. These fields are used in the amendment process to link which trade record amends which other one. Note that amend trade ID 905 is null for an original trade that has no amendments. In one embodiment of the present invention, the system creates an amending trade in the database or communicates one that has the same amend trade ID 905 field as a trade record that is already in the database. The system also refuses to make further changes to a trade record that has an amending trade record whose amend trade ID 905 field points to it. If a new amendment is made to a previously amended trade, the amend trade ID 905 field of the new amendment reflects the value of the trade ID 903 field of the previously amended trade. In one embodiment of the present invention, the trade record may also contain an original trade ID field 907. For new trades, this field 907 stores the same value as trade ID field 905. For amended trades, this field 907 stores the trade ID of the original trade that the amendment modifies. If the amendment modifies a previous amendment, this field 907 should reference the original trade ID. This field can be used to link related trades and amendments to an provide an efficient index for trade queries.

Status field 901 indicates a status of the trade record. For example, the trade record may have a status of “pending,” “valid,” “old” or “cancelled pending.” “Pending” indicates that the record has not yet been agreed upon between the two parties to the trade. “Valid” indicates that the trade record has been agreed to between the parties is currently in force. “Old” indicates that the trade record has been superceded by an amended trade record. “Cancelled pending” indicates that the trade record was never agreed to, and was superceded by another amended trade record. Note that status field 901 is not signed because it is computable from the other trades and is added by CX 200 as a convenience for reporting.

Trade date 902 identifies the date the trade took place, and value date 904 which identifies the date the currency is to be exchanged.

Currency 1 (CCY1) identifier 906 identifies a first currency involved in the trade (such as US Dollars). CCY1 amount 908 specifies an amount of the first currency involved in the trade. CCY2 identifier 910 identifies a second currency involved in the trade (such as Japanese Yen). CCY2 amount 912 specifies an amount of the second currency involved in the trade. Conversion rate 914 specifies a conversion rate between the first currency and the second currency.

CCY1 organization 916 identifies a first organization involved in the trade, and CCY1 subsidiary 918 identifies a specific subsidiary of the first organization that is involved in the trade. CCY2 organization 920 identifies a second organization involved in the trade, and CCY2 subsidiary 922 identifies a specific subsidiary of the second organization that is involved in the trade.

CCY1 account 924 identifies and account for the first organization, and CCY1 custodian 926 identifies an institution (bank) maintaining the account for the first organization. CCY2 account 928 identifies and account for the second organization, and CCY2 custodian 930 identifies an institution maintaining the account for the second organization.

There are also trading, settlement and settlement approval signatures for currency one, 932, 934 and 935, as well as trading, settlement and settlement approval signatures for currency two, 936, 938 and 939.

Note that certain portions of trade record 900 are signed by a user, such as front office trader 310, and other portions are signed by a settlement clerk, such as settlement clerk 311. In particular, front office trader 310 signs portions of trade record 900 that include trade parameters. Settlement clerk 311 (and a settlement approver) signs these as well as the portions of trade record 900 that contain settlement instructions, such as account identifiers. (The “1” values in FIG. 9 indicate which portions of the trade record are signed by respective entities, the “-” values indicate portions which are not signed, and the “S” values indicate the respective digital signatures.)

Policy Approval Record Structure

Policy Approval Records are used as a control mechanism for ensuring that the proper authorization checks are performed by the system. The policy approval records are made up of authorization rules and a set of associated digital signatures that validate those rules. An initial policy approval record may be bootstrapped into the system. This initial record should ideally impose a base restriction that all policy approval records must be signed by a minimum of two security officers and the policy itself should be signed by the two original exchange security officers (the exchange PSO and CSO). This requirement prevents a single individual from perpetrating fraud in the system by relaxing authorization safeguards.

From this base policy, additional policy approval records can then be defined to further configure the system's permission handling functions. For instance, policies can be defined to enforce things such as the number of signatures required to approve a trade or an amendment. These policies are confirmed against all actions performed on the system to ensure that the requisite validations have been met.

Process of Establishing a Policy for Approvals

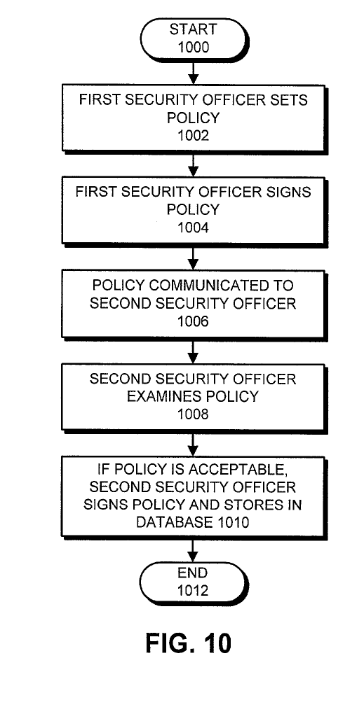

FIG. 10 is a flow chart illustrating the process of establishing a policy for approvals relating to trades and amendments in accordance with an embodiment of the present invention. A first security officer for an organization (such as for example security officer 312 or 316) first sets the new policy or amends an existing policy to create a new policy (step 1002), and then signs the new policy (step 1004). In order to conform to the bootstrapped system policy, which dictates dual signatures for new policies, the new policy is then communicated to a second security officer within the same organization (step 1006). This second security officer examines the new policy (step 1008). If the new policy properly conforms to established rules for the organization, the second security officer signs the new policy and stores it in database 301, which causes the new policy to come into force (step 1010). Note that by requiring at least two security officers within an organization to approve policy changes, a single security officer is unable to unilaterally change the organization's security policy.

For instance, a Permission Security Officer (PSO) may propose a policy that requires two settlement clerks to sign and approve a trade settlement instruction. The PSO generates a policy approval record defining that rule set and signs the record. The PSO must then get a second security officer to agree to sign the rule set in order to validate the policy in the system. Once the policy has been defined and validated, the system will impose the new dual signature requirement on any new trade settlement instructions.

Entities Involved in the Settlement Process

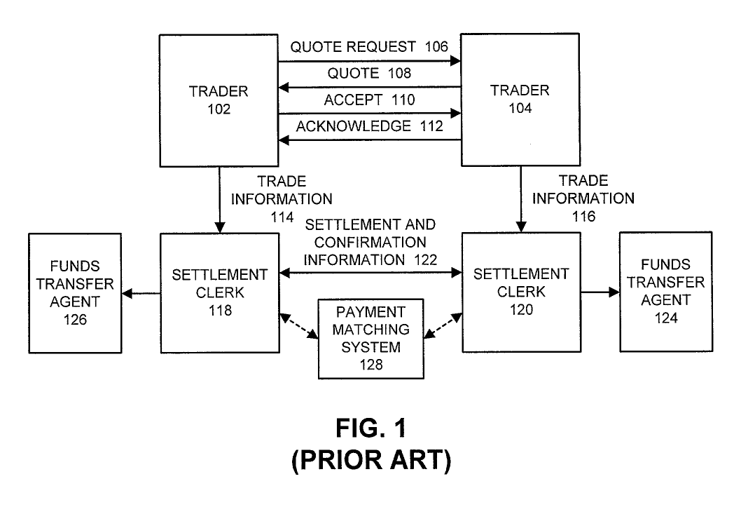

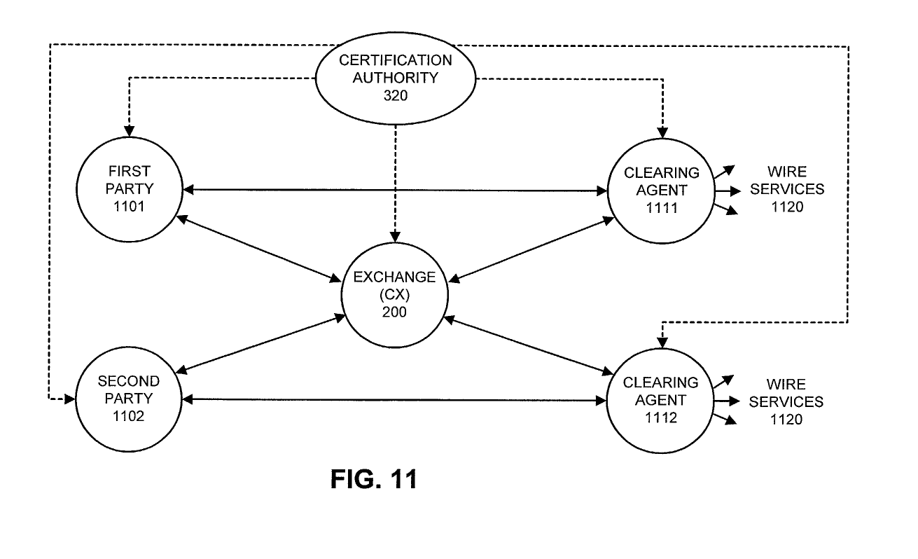

FIG. 11 illustrates entities involved in the settlement process in accordance with an embodiment of the present invention. In this embodiment, the financial transaction involves an exchange of currencies between a first party 1101 and a second party 1102. Note that parties 1101 and 1102 can include any two parties in a foreign exchange transaction, such as parties 202-204 and 208-210 in FIG. 1, or parties 302 and 304 in FIG. 3.

Parties 1101 and 1102 first communicate through exchange (CX) 200 to establish and sign a trade record with settlement instructions as is discussed above. Exchange 200 then passes this trade record on to clearing agents 1111-1112, who communicate through wire services 1120 (or other communication pathways) to actually move funds between accounts to complete the transaction. For example, clearing agents may use wire services or payment systems belonging to SWIFT, CHIPS, CEDEL, ACH and even VISA to move funds.

Note that the process of authorization and authentication is facilitated by certification authority 320 as is discussed above.

Settlement Process

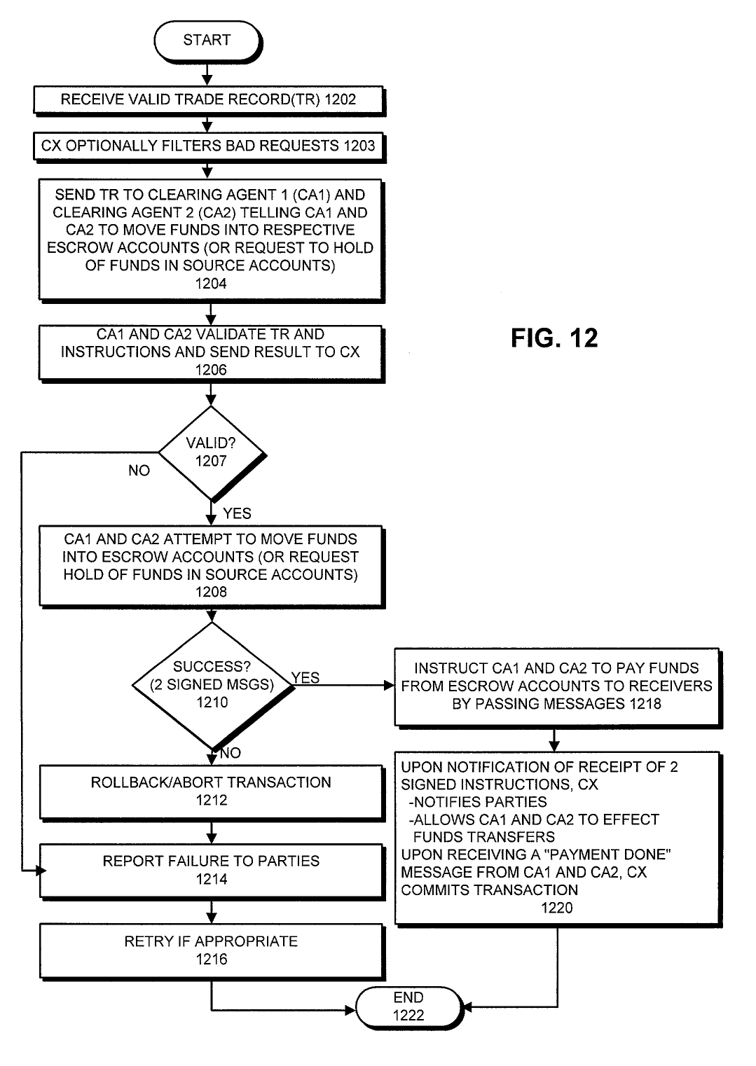

FIG. 12 is a flow chart illustrating the settlement process in accordance with an embodiment of the present invention. The process starts when a complete and valid trade record 900 is received by CX 200 (step 1202). CX 200 optionally checks the signatures of trade record 900 (step 1203) and sends trade record 900 to clearing agents 1111 and 1112 along with instructions to move funds for the transaction into escrow accounts (or to place holds on the funds in the source accounts) according to the information in the trade record 900 (step 1204).

Next, clearing agents 1111 and 1112 validate trade record 900 and the accompanying instructions using digital signatures as is described above in preceding sections of this disclosure (step 1206).

If trade record 900 and the accompanying instructions are successfully validated, clearing agents 1111 and 1112 attempt to move funds for the trade into escrow accounts (or attempt to place holds on the funds in the source accounts) (step 1208). If the funds are successfully moved (or if the holds are successfully placed) clearing agents 1111 and 1112 indicate this by sending a signed message of success to CX 200. If both messages are valid and indicate success, CX 200 instructs clearing agents 1111 and 1112 to move funds from the escrow accounts (or source accounts) into the destination accounts specified by the settlement instructions (step 1218) by forwarding the corresponding signed message of success to each of clearing agents 1111 and 1112.

Upon receiving notification of receipt of these instructions from clearing agents 1111 and 1112, CX 200 notifies parties 1101 and 1102 that clearing agents 1111 and 1112 have received the instructions and allows clearing agents 1111 and 1112 to transfer the funds. Furthermore, upon receiving a “payment done” message from clearing agents 1111 and 1112, CX 200 commits the transaction to a database (step 1220). Note that after clearing agents 1111 and 1112 receive the instructions, CX 200 is not responsible for ensuring that the funds are transferred. Clearing agents 1111 and 1112 assume this responsibility.

Also note that if the funds are successfully moved (or if the holds are successfully placed) at step 1210, an “advice of funds” or “advice of credit” communication can be sent to parties 1101 and 1102 to let them know that they should expect to receive the funds.

If the funds are not successfully moved into the escrow accounts (or if holds cannot be placed on the funds) in step 1208, the system rolls back the transaction (step 1212) and reports the failure to parties 1101 and 1102 as well as clearing agents 1111 and 1112 (step 1214). The system also retries the transaction if appropriate (step 1216).

If clearing agents 1111 and 1112 cannot validate the trade record and instructions in step 1206, the system reports the failure to parties 1101 and 1102 as well as clearing agents 1111 and 1112 (step 1214) and retries the transaction if appropriate (step 1216).

Note that if the system places holds on the funds in the source accounts rather than moving the funds through an escrow account, then it only requires a single wire transfer into each destination account rather than two transfers for each destination account. However, note that moving the funds through escrow accounts provides more assurance that the funds will be available to complete the transaction.

Also note that although the present invention is described in terms of two clearing agents 1111 and 1112 and two associated escrow accounts, the present invention is not meant to be limited to such a configuration. For example, the present invention can be applied to systems that use a single clearing agent and a single escrow account, such as the Continuous-Linked Settlement (CLS) system.

Settlement Process with Payment Guarantee

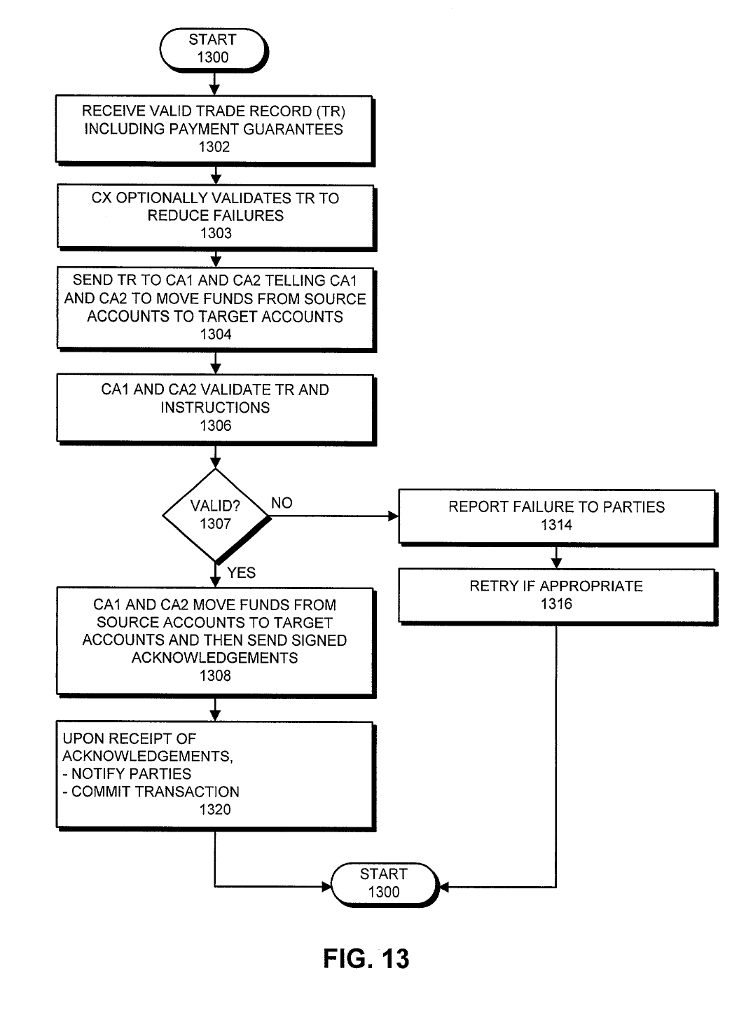

FIG. 13 is a flow chart illustrating the settlement process in accordance with an embodiment of the present invention. The process starts when a complete and valid trade record 900 is received by CX 200 (step 1302).

In this embodiment, trade record 900 includes payment guarantees from the parties 1101 and 1102. A payment guarantee can indicate that a hold has been placed on the required funds in the source account, or alternatively, a payment guarantee can be the payment instrument itself in digital form, such as digital cash. Note that these payment guarantees are provided by the parties 1101-1102 during the negotiations which caused trade record 900 to be formed.

CX 200 optionally checks the signatures of trade record 900 (step 1303). CX 200 and sends trade record 900 to clearing agents 1111 and 1112 along with instructions to move funds into destination accounts to complete the transaction (step 1304).

Next, clearing agents 1111 and 1112 validate trade record 900 and the accompanying instructions using digital signatures (step 1306).

If trade record 900 and the accompanying instructions are successfully validated, CX 200 instructs clearing agents 1111 and 1112 to move funds for the trade into destination accounts according to the information in the trade record 900. Clearing agents 1111 and 1112 then move the funds and send signed acknowledgements to CX 200 (step 1308)

Upon receiving signed notification of receipt and status of these instructions from clearing agents 1111 and 1112, CX 200 notifies parties 1101 and 1102 that clearing agents 1111 and 1112 have carried out the instructions by forwarding the signed receipts. CX 200 also commits the transaction to a database (step 1320).

If clearing agents 1111 and 1112 cannot validate trade record 900 and the instructions in step 1306, the system reports the failure to parties 1101 and 1102 (step 1314) and retries the transaction if appropriate (step 1316).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for automatically settling a financial transaction, comprising:
receiving a trade record specifying previously-agreed-to details of the financial transaction between a first party and a second party;
wherein the trade record includes settlement instructions specifying a first transfer of a first financial instrument belonging to the first party into a second party destination account belonging to the second party;
wherein the trade record includes a second digital signature created by digitally signing at least a portion of the trade record including the settlement instructions with a second private key belonging to the second party;
ensuring that funds are available to complete the financial transaction; and
if funds are ensured to be available, causing the first transfer of the first financial instrument into the second party destination account on condition that the second digital signature can be verified using a corresponding second public key.

2. The method of claim 1,
wherein the settlement instructions additionally specify a first party source account belonging to the first party, from which the first financial instrument is to be transferred; and
wherein the trade record additionally includes a first digital signature created by digitally signing at least a portion of the trade record including the settlement instructions with a first private key belonging to the first party.

3. The method of claim 1, wherein causing the first transfer involves communicating at least a portion of the trade record, including the settlement instructions and the second digital signature, to a first clearing agent so that the first clearing agent can use the corresponding second public key to verify that the second digital signature was created using the second private key prior to transferring the first financial instrument into the second party destination account.

4. The method of claim 1,
wherein the settlement instructions additionally specify a second transfer of a second financial instrument to a first party destination account; and
wherein the trade record includes a first digital signature created by digitally signing at least a portion of the trade record including the settlement instructions using a first private key belonging to the first party.

5. The method of claim 4, wherein causing the second transfer involves communicating at least a portion of the trade record, including the settlement instructions and the first digital signature, to a second clearing agent, so that the second clearing agent can use a first public key to verify that the first digital signature was created using the first private key prior to transferring the second financial instrument into the first party destination account.

6. The method of claim 1, wherein ensuring that funds are available to complete the financial transaction involves causing the first transfer of the first financial instrument from the first party into a first escrow account, so that the first financial instrument is available to be transferred into the second party destination account.

7. The method of claim 1,
wherein the settlement instructions additionally specify a first party source account belonging to the first party, from which the first financial instrument is to be transferred to the second party destination account; and
wherein ensuring that funds are available to complete the financial transaction involves causing a hold to be placed on the first financial instrument within the first party source account, so that the first financial instrument is ensured to be available to be transferred into the second party destination account.

8. The method of claim 1,
wherein ensuring funds are available to complete the financial transaction involves verifying a payment guarantee contained within the trade record, the payment guarantee having been previously provided by the first party; and
wherein the payment guarantee ensures that the first financial instrument is available to be transferred to the second party destination account.

9. The method of claim 8, wherein the payment guarantee includes a record that a hold has been placed on the first financial instrument within a first source account belonging to the first party.

10. The method of claim 8, wherein the payment guarantee includes a digital form of the first financial instrument.

11. The method of claim 1, further comprising recording the settlement operation in a database.

12. The method of claim 1, further comprising validating an identity of the first party by using a public key of a certification authority to verify that a certificate containing the public key of the first party was signed by a corresponding private key belonging to the certification authority;
wherein the signing by the certification authority indicates that the certification authority has verified the identity of the first party.

13. The method of claim 1, wherein the financial transaction involves foreign exchange, and wherein a trade record for the financial transaction includes:
a trade identifier;
a trade date;
an identifier for a first currency;
a first currency amount;
an identifier for a first organization providing the first currency;
an identifier for a second currency;
a second currency amount; and
an identifier for a second organization providing the second currency.

14. A computer-readable storage medium storing instructions that when executed by a computer cause the computer to perform a method for automatically settling a financial transaction, the method comprising:
receiving a trade record specifying previously-agreed-to details of the financial transaction between a first party and a second party;
wherein the trade record includes settlement instructions specifying a first transfer of a first financial instrument belonging to the first party into a second party destination account belonging to the second party;
wherein the trade record includes a second digital signature created by digitally signing at least a portion of the trade record including the settlement instructions with a second private key belonging to the second party;
ensuring that funds are available to complete the financial transaction; and
if funds are ensured to be available, causing the first transfer of the first financial instrument into the second party destination account on condition that the second digital signature can be verified using a corresponding second public key.

15. The computer-readable storage medium of claim 14,
wherein the settlement instructions additionally specify a first party source account belonging to the first party, from which the first financial instrument is to be transferred; and
wherein the trade record additionally includes a first digital signature created by digitally signing at least a portion of the trade record including the settlement instructions with a first private key belonging to the first party.

16. The computer-readable storage medium of claim 14, wherein causing the first transfer involves communicating at least a portion of the trade record, including the settlement instructions and the second digital signature, to a first clearing agent so that the first clearing agent can use the corresponding second public key to verify that the second digital signature was created using the second private key prior to transferring the first financial instrument into the second party destination account.

17. The computer-readable storage medium of claim 14,
wherein the settlement instructions additionally specify a second transfer of a second financial instrument to a first party destination account; and
wherein the trade record includes a first digital signature created by digitally signing at least a portion of the trade record including the settlement instructions using a first private key belonging to the first party.

18. The computer-readable storage medium of claim 17, wherein causing the second transfer involves communicating at least a portion of the trade record, including the settlement instructions and the first digital signature, to a second clearing agent, so that the second clearing agent can use a first public key to verify that the first digital signature was created using the first private key prior to transferring the second financial instrument into the first party destination account.

19. The computer-readable storage medium of claim 14, wherein ensuring that funds are available to complete the financial transaction involves causing the first transfer of the first financial instrument from the first party into a first escrow account, so that the first financial instrument is available to be transferred into the second party destination account.

20. The computer-readable storage medium of claim 14,
wherein the settlement instructions additionally specify a first party source account belonging to the first party, from which the first financial instrument is to be transferred to the second party destination account; and
wherein ensuring that funds are available to complete the financial transaction involves causing a hold to be placed on the first financial instrument within the first party source account, so that the first financial instrument is ensured to be available to be transferred into the second party destination account.

21. The computer-readable storage medium of claim 14,
wherein ensuring funds are available to complete the financial transaction involves verifying a payment guarantee contained within the trade record, the payment guarantee having been previously provided by the first party;
wherein the payment guarantee ensures that the first financial instrument is available to be transferred to the second party destination account.

22. The computer-readable storage medium of claim 21, wherein the payment guarantee includes a record that a hold has been placed on the first financial instrument within a first source account belonging to the first party.

23. The computer-readable storage medium of claim 21, wherein the payment guarantee includes a digital form of the first financial instrument.

24. The computer-readable storage medium of claim 14, wherein the method further comprises recording the settlement operation in a database.

25. The computer-readable storage medium of claim 14, wherein the method further comprises validating an identity of the first party by using a public key of a certification authority to verify that a certificate containing the public key of the first party was signed by a corresponding private key belonging to the certification authority;
wherein the signing by the certification authority indicates that the certification authority has verified the identity of the first party.

26. The computer-readable storage medium of claim 14, wherein the financial transaction involves foreign exchange, and wherein a trade record for the financial transaction includes:
a trade identifier;
a trade date;
an identifier for a first currency;
a first currency amount;
an identifier for a first organization providing the first currency;
an identifier for a second currency;
a second currency amount; and
an identifier for a second organization providing the second currency.

27. An apparatus that automatically settles a financial transaction, comprising:
a receiving mechanism that is configured to receive a trade record specifying previously-agreed-to details of the financial transaction between a first party and a second party;
wherein the trade record includes settlement instructions specifying a first transfer of a first financial instrument belonging to the first party into a second party destination account belonging to the second party;
wherein the trade record includes a second digital signature created by digitally signing at least a portion of the trade record including the settlement instructions with a second private key belonging to the second party; and
a transferring mechanism that is configured to, ensure that funds are available to complete the financial transaction, and if funds are ensured to be available, to cause the first transfer of the first financial instrument into the second party destination account on condition that the second digital signature can be verified using a corresponding second public key.

28. The apparatus of claim 27,
wherein the settlement instructions additionally specify a first party source account belonging to the first party, from which the first financial instrument is to be transferred; and
wherein the trade record additionally includes a first digital signature created by digitally signing at least a portion of the trade record including the settlement instructions with a first private key belonging to the first party.

29. The apparatus of claim 27, wherein the transferring mechanism is configured to cause the first transfer by communicating at least a portion of the trade record, including the settlement instructions and the second digital signature, to a first clearing agent so that the first clearing agent can use the corresponding second public key to verify that the second digital signature was created using the second private key prior to transferring the first financial instrument into the second party destination account.

30. The apparatus of claim 27,
wherein the settlement instructions additionally specify a second transfer of a second financial instrument to a first party destination account; and
wherein the trade record includes a first digital signature created by digitally signing at least a portion of the trade record including the settlement instructions using a first private key belonging to the first party.

31. The apparatus of claim 30, wherein the transferring mechanism is configured to cause the second transfer by communicating at least a portion of the trade record, including the settlement instructions and the first digital signature, to a second clearing agent, so that the second clearing agent can use a first public key to verify that the first digital signature was created using the first private key prior to transferring the second financial instrument into the first party destination account.

32. The apparatus of claim 27, wherein the transferring mechanism is configured to ensure that funds are available to complete the financial transaction by causing the first transfer of the first financial instrument from the first party into a first escrow account, so that the first financial instrument is available to be transferred into the second party destination account.

33. The apparatus of claim 27,
wherein the settlement instructions additionally specify a first party source account belonging to the first party, from which the first financial instrument is to be transferred to the second party destination account; and
wherein the transferring mechanism is configured to ensure that funds are available to complete the financial transaction by causing a hold to be placed on the first financial instrument within the first party source account, so that the first financial instrument is ensured to be available to be transferred into the second party destination account.

34. The apparatus of claim 27,
wherein the transferring mechanism is configured to ensure that funds are available to complete the financial transaction by verifying a payment guarantee contained within the trade record, the payment guarantee having been previously provided by the first party; and
wherein the payment guarantee ensures that the first financial instrument is available to be transferred to the second party destination account.

35. The apparatus of claim 34, wherein the payment guarantee includes a record that a hold has been placed on the first financial instrument within a first source account belonging to the first party.

36. The apparatus of claim 34, wherein the payment guarantee includes a digital form of the first financial instrument.

37. The apparatus of claim 27, further comprising a recording mechanism that is configured to record the settlement operation in a database.

38. The apparatus of claim 27, further comprising a validation mechanism that is configured to validate an identity of the first party by using a public key of a certification authority to verify that a certificate containing the public key of the first party was signed by a corresponding private key belonging to the certification authority;
wherein the signing by the certification authority indicates that the certification authority has verified the identity of the first party.

39. The apparatus of claim 27, wherein the financial transaction involves foreign exchange, and wherein a trade record for the financial transaction includes:
a trade identifier;
a trade date;
an identifier for a first currency;
a first currency amount;
an identifier for a first organization providing the first currency;
an identifier for a second currency;
a second currency amount; and
an identifier for a second organization providing the second currency.
